(19) United States
(12) Patent Application Publication
(10) Pub. No.: US 2021/0114110 A1
(43) Pub. Date: Apr. 22, 2021

(54) ADDITIVE FABRICATION WITH INFILTRATION BARRIERS

(71) Applicant: Desktop Metal, Inc., Burlington, MA (US)

(72) Inventors: Timothy Sercombe, Crawley (AU); Ellen Benn, Cambridge, MA (US); Michael Andrew Gibson, Boston, MA (US); Nihan Tuncer, Cambridge, MA (US)

(73) Assignee: Desktop Metal, Inc., Burlington, MA (US)

(21) Appl. No.: 17/251,806

(22) PCT Filed: Jul. 12, 2019
(86) PCT No.: PCT/US2019/041712

§ 371 Date: Dec. 13, 2020

Related U.S. Application Data
(60) Provisional application No. 62/697,897, filed on Jul. 13, 2018.

(51) Int. Cl. B22F 10/60; B28B 1/00; B33Y 10/00; B33Y 40/20

(52) U.S. Cl. CPC B22F 10/60; B28B 1/001; B22F 2301/35; B33Y 40/20; B22F 2998/10; B33Y 10/00

(57) ABSTRACT

A method of maintaining part geometry fidelity during infiltration of a metallic preform. The preform and an infiltration barrier are formed, either independently or together during an additive manufacturing process. The infiltration barrier prevents infiltrant from bleeding out from the preform where it is present, thus protecting fine geometries that would otherwise be filled with infiltrant.

### FIELD OF THE DISCLOSURE

The subject matter of the present disclosure generally relates to infiltration of objects, and more particularly relates to maintaining desired part geometry in infiltrated objects.

### BACKGROUND OF THE DISCLOSURE

Infiltration is a processing technique often used to strengthen porous bodies formed from powders. During infiltration, a porous preform (often called a skeletal structure or skeleton) is formed via additive manufacturing, casting, or other techniques common for shaping porous bodies. A molten second material is then put into contact with said skeletal structure, and the molten material wicks into the skeletal structure under the force of its surface tension.

There are various material systems for the preform material and the infiltrant that are known in the art. For example, prior work has shown that infiltration may be useful in aluminum powder metallurgy, where aluminum alloys are shaped and then sintered in nitrogen environments. The reaction of the aluminum with the nitrogen forms aluminum nitride coatings on the surface of the metal particles with minimal shrinkage during the nitriding operation and high porosity within the part. A secondary alloy of the same or different composition is introduced such that it fills this porosity via capillary forces, forming a dense structure consisting of a frame of one material infiltrated with molten metal of another. An example of this infiltration process is described in U.S. Pat. No. 7,036,550 titled “Infiltrated Aluminum Preforms” and filed Mar. 15, 2004, the entire contents of which are incorporated by reference herein. Infiltration is also common in the powder metallurgy of steels, wherein a steel skeleton may be used to wick in a copper infiltrant. Other examples of infiltrating systems include silicon carbide infiltrated with liquid silicon, silicon carbide infiltrated with liquid aluminum, and stainless steel infiltrated with bronze.

It is desirable in certain instances to fabricate a preform for infiltration using additive manufacturing processes as these processes provide excellent ability to accommodate varying part geometries, rapid prototyping and generally avoid the need for molds, which are expensive and limit part geometry. Further techniques and disclosure related to infiltration can be found in U.S. Patent Publication No. 2018/0305266-A1 titled “Additive Fabrication of Infiltrable Structures” and filed Apr. 24, 2018, the entire contents of which are incorporated by reference herein.

It can be challenging in practicing infiltration to determine precisely the amount of infiltrant to be used in infiltrating a part. If too little infiltrant is used, large voids may be left in the final part which can be detrimental to the part's mechanical properties. If too much infiltrant is used, the excess infiltrant may “bleed” from surfaces of the part, reducing dimensional accuracy and potentially requiring post-processing. Even where the amount of infiltrant is well matched to the preform, small surface geometries may be inadvertently filled with infiltrant that wets through the face of the preform.

The subject matter of the present disclosure is directed to overcoming, or at least reducing the effects of, one or more of the problems set forth above.

### BRIEF SUMMARY OF THE DISCLOSURE

Disclosed is a method of maintaining part geometry fidelity during infiltration of a metallic three-dimensional object. A preform is formed in a desired shape. An infiltration barrier is formed on at least a portion of the surface of the preform where there is geometry for which protection is desired. The infiltration barrier may be co-fabricated with the preform in certain embodiments. The preform is then infiltrated. The infiltration barrier prevents the infiltrant from wetting through the surface of the preform, thus maintaining the desired part geometry.

The subject matter of the present disclosure is particularly applicable to additive manufacturing, where there is an ability to easily accommodate fine and complex geometries.

### BRIEF DESCRIPTION OF THE DRAWINGS

The foregoing summary, preferred embodiments, and other aspects of the present disclosure will be best understood with reference to a detailed description of specific embodiments, which follows, when read in conjunction with the accompanying drawings, in which:

FIGS. 1A-D depict a bound metal deposition system for use in forming a preform.

FIGS. 2A-C depict a powder bed binder jetting system for use in forming a preform.

FIG. 3 is a flow chart of an embodiment infiltration barrier process.

FIGS. 4A-D depict a cross-section of a part undergoing an embodiment process.

FIG. 5 depicts an infiltration barrier system demonstrated using dipped bars of

Like reference numbers and designations in the various drawings indicate like elements.

### DETAILED DESCRIPTION

In general, infiltration of parts may make it difficult to preserve high resolution features such as small features, sharp angles, and desired hollow spaces within a part because these geometries can become filled when wetted with an infiltrating liquid. Currently, many of these features can only be achieved in infiltrated parts through post-processing or machining, adding additional time and cost into the manufacturing of parts, or reduced value via necessitating design of parts without these sorts of characteristics. However, these features may be preserved by incorporating a non-wetting interface layer as a mask to prevent infiltration into undesired areas. Simultaneously, additive manufacturing, also known as 3D printing, has enabled the formation of much more complex and detailed infiltration preforms with comparative ease and low cost that could not be readily accomplished with traditional manufacturing techniques such as molding. In complex, additively manufactured parts problematic geometries may also be introduced without the knowledge of the user. The preservation of geometric fidelity in infiltrated parts is thus a uniquely acute need in additive manufacturing.

Formation of the Preform

Described now are several emblematic manufacturing systems and methods with which the present disclosure may be employed to form the initial shape of an object to be infiltrated. Generally, any manufacturing technique capable of allowing the formation of a shape of a desired part to be formed may be employed. Non-limiting examples of additive manufacturing techniques that may be employed include bound metal deposition, powder bed binder jetting, stereolithographic printing, and selective laser sintering. An example of a bound metal deposition system for use with the disclosed technology is the Studio system by DESKTOP METAL, INC. of Burlington, Mass. An example of a powder bed binder jetting system for use with the disclosed technology is the Production system by DESKTOP METAL, INC. of Burlington, Mass. Other manufacturing techniques, such as injection of the composite into a mold, may also be employed. Other techniques for forming the preform include slip casting, pressing or powder into a preform, machining a preform from a pre-manufactured blank, injection of a suspension into a mold, and vibratory filling of a die with powders and polymeric binders and subsequently heating the die to bond the binders together.

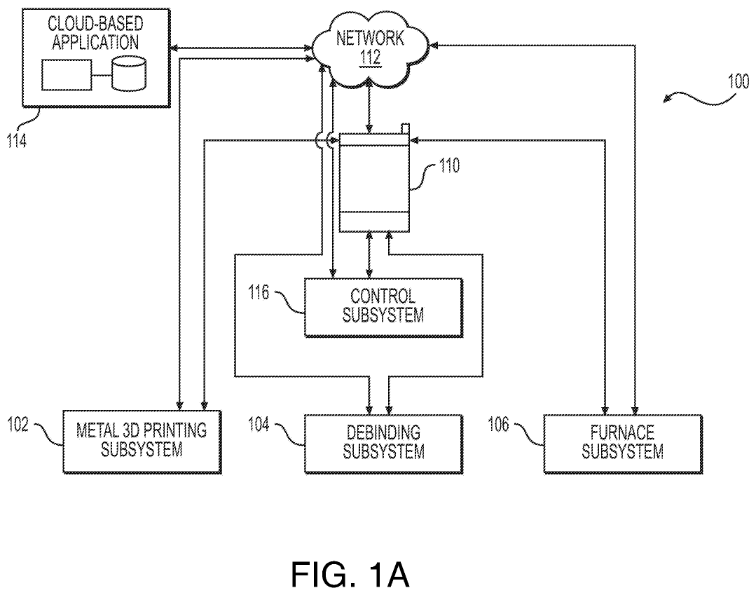

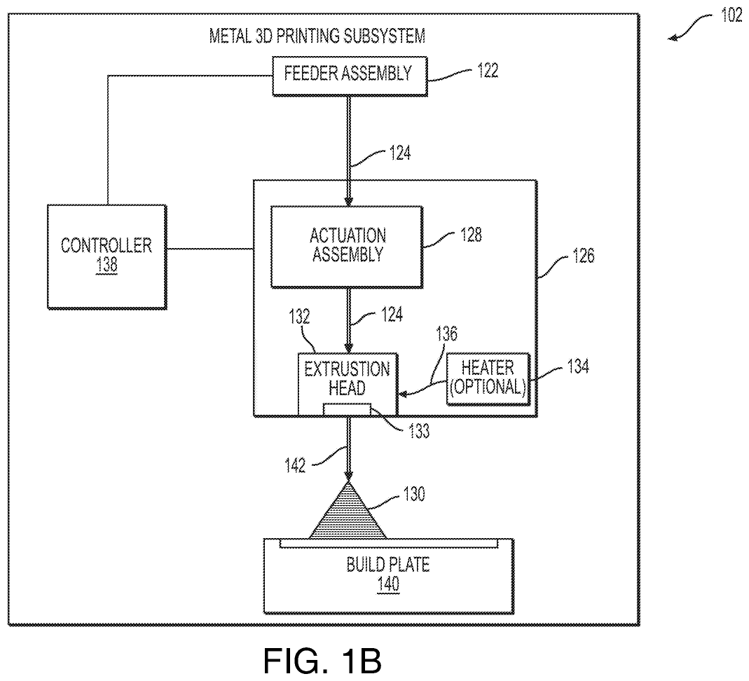

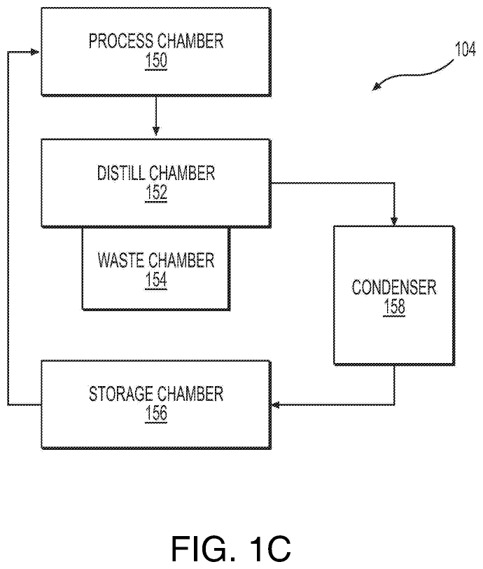

FIG. 1A illustrates an exemplary system 100 for forming a printed object, according to an embodiment of the present disclosure. System 100 may include a three-dimensional (3D) printer, for example, a metal 3D printing subsystem 102, and one or more treatment site(s), for example, a debinding subsystem 104 and a furnace subsystem 106, for treating the green part after printing. Metal 3D printing subsystem 102 may be used to form an object from a build material, for example, by depositing successive layers of the build material onto a build plate. The build material may include metal powder and at least one binder material. In some embodiments, the build material may include a primary binder material (e.g., a wax) and a secondary binder material (e.g., a polymer). A binder system may include a single binder or a primary binder and a secondary binder.

Debinding subsystem 104 may be configured to treat the printed object by performing a first debinding process, in which the primary binder material may be removed. In some embodiments, the first debinding process may be a chemical debinding process, as will be described in further detail with reference to FIG. 1C. In such embodiments, the primary binder material may dissolve in a debinding fluid while the secondary binder material remains, holding the metal particles in place in their printed form.

In other embodiments, the first debinding process may comprise a thermal debinding process. In such embodiments, the primary binder material may have a vaporization temperature lower than that of the secondary binder material. The debinding subsystem 104 may be configured to heat the deposited build material to a temperature at or above the vaporization temperature of the primary binder material and below the vaporization temperature of the secondary binder material such that the primary binder material is removed from the printed part. In alternative embodiments, the furnace subsystem 106 rather than a separate heating debinding subsystem 104 may be configured to perform the first debinding process. For example, the furnace subsystem 106 may be configured to heat the deposited build material to a temperature at or above the vaporization temperature of the primary binder material and below the vaporization temperature of the secondary binder material such that the primary binder material is removed from the deposited build material.

Furnace subsystem 106 may be configured to treat the printed object by performing a secondary thermal debinding process (or also a primary debinding process, as in the alternative embodiment described above), in which the secondary binder material and/or any remaining primary binder material may be vaporized and removed from the printed part. In some embodiments, the secondary debinding process may comprise a thermal debinding process, in which the furnace subsystem 106 may be configured to heat the part to a temperature at or above the vaporization temperature of the secondary binder material to remove the secondary binder material. The furnace subsystem 106 may then heat the part to a temperature just below the melting point of the metal powder to sinter the metal powder and to densify the metal powder into a solid metal part.

As shown in FIG. 1A, system 100 may also include a user interface 110, which may be operatively coupled to one or more components, for example, to metal 3D printing subsystem 102, debinding subsystem 104, and furnace subsystem 106, etc. In some embodiments, user interface 110 may be a remote device (e.g., a computer, a tablet, a smartphone, a laptop, etc.) or an interface incorporated into system 100, e.g., on one or more of the components. User interface 110 may be wired or wirelessly connected to one or more of metal 3D printing subsystem 102, debinding subsystem 104, and/or furnace subsystem 106. System 100 may also include a control subsystem 116, which may be included in user interface 110, or may be a separate element.

Metal 3D printing subsystem 102, debinding subsystem 104, furnace subsystem 106, user interface 110, and/or control subsystem 116 may each be connected to the other components of system 100 directly or via a network 112. Network 112 may include the Internet and may provide communication through one or more computers, servers, and/or handheld mobile devices, including the various components of system 100. For example, network 112 may provide a data transfer connection between the various components, permitting transfer of data including, e.g., part geometries, printing material, one or more support and/or support interface details, printing instructions, binder materials, heating and/or sintering times and temperatures, etc., for one or more parts or one or more parts to be printed.

Moreover, network 112 may be connected to a cloud-based application 114, which may also provide a data transfer connection between the various components and cloud-based application 114 in order to provide a data transfer connection, as discussed above. Cloud-based application 114 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of metal 3D printing subsystem 102, debinding subsystem 104, sintering furnace subsystem 106, user interface 110, and/or control subsystem 116. In this aspect, metal 3D printing subsystem 102, debinding subsystem 104, furnace subsystem 106, user interface 110, and/or control subsystem 116 may be disconnected from the Internet and/or other networks, which may increase security protections for the components of system 100. In either aspect, an additional controller (not shown) may be associated with one or more of metal 3D printing subsystem 102, debinding subsystem 104, and furnace subsystem 106, etc., and may be configured to receive instructions to form the printed object and to instruct one or more components of system 100 to form the printed object.

FIG. 1B is a block diagram of a metal 3D printing subsystem 102 according to one embodiment. The metal 3D printing subsystem 102 may extrude build material 124 to form a three-dimensional part. As described above, the build material may include a mixture of metal powder and binder material. For example, the build material may include any combination of metal powder, plastics, wax, ceramics, polymers, among others. In some embodiments, the build material 124 may come in the form of a rod comprising a predetermined composition of metal powder and one or more binder components (e.g., a primary and a secondary binder).

Metal 3D printing subsystem 102 may include an extrusion assembly 126 comprising an extrusion head 132. Metal 3D printing subsystem 102 may include an actuation assembly 128 configured to propel the build material 124 into the extrusion head 132. For example, the actuation assembly 128 may be configured to propel the build material 124 in a rod form into the extrusion head 132. In some embodiments, the build material 124 may be continuously provided from the feeder assembly 122 to the actuation assembly 128, which in turn propels the build material 124 into the extrusion head 132. In some embodiments, the actuation assembly 128 may employ a linear actuation to continuously grip and/or push the build material 124 from the feeder assembly 122 towards the extrusion head 132.

In some embodiments, the metal 3D printing subsystem 102 includes a heater 134 configured to generate heat 136 such that the build material 124 propelled into the extrusion head 132 may be heated to a workable state. In some embodiments, the heated build material 124 may be extruded through a nozzle 133 to extrude workable build material 142 onto a build plate 140. It is understood that the heater 134 is an exemplary device for generating heat 136, and that heat 136 may be generated in any suitable way, e.g., via friction of the build material 124 interacting with the extrusion assembly 126, in alternative embodiments. While there is one nozzle 133 shown in FIG. 1B, it is understood that the extrusion assembly 126 may comprise more than one nozzle in other embodiments. In some embodiments, the metal 3D printing subsystem 102 may include another extrusion assembly (not shown in FIG. 1B) configured to extrude a non-sintering ceramic material onto the build plate 140.

In some embodiments, the metal 3D printing subsystem 102 comprises a controller 138. The controller 138 may be configured to position the nozzle 133 along an extrusion path relative to the build plate 140 such that the workable build material is deposited on the build plate 140 to fabricate a three dimensional printed object 130. The controller 138 may be configured to manage operation of the metal 3D printing subsystem 102 to fabricate the printed object 130 according to a three-dimensional model. In some embodiments, the controller 138 may be remote or local to the metallic printing subsystem 102. The controller 138 may be a centralized or distributed system. In some embodiments, the controller 138 may be configured to control a feeder assembly 122 to dispense the build material 124. In some embodiments, the controller 138 may be configured to control the extrusion assembly 126, e.g., the actuation assembly 128, the heater 134, the extrusion head 132, and/or the nozzle 133. In some embodiments, the controller 138 may be included in the control subsystem 116.

FIG. 1C depicts a block diagram of a debinder subsystem 104 for debinding a printed object 130 according to one embodiment. The debinder subsystem 104 may include a process chamber 150, into which the printed object 130 may be inserted for a first debinding process. In some embodiments, the first debinding process may be a chemical debinding process. In such embodiments, the debinder subsystem 104 may include a storage chamber 156 to store a volume of debinding fluid, e.g., a solvent, for use in the first debinding process. The storage chamber 156 may comprise a port which may be used to fill, refill, and/or drain the storage chamber 156 with the debinding fluid. In some embodiments, the storage chamber 156 may be removably attached to the debinder subsystem 104. In such embodiments, the storage chamber 156 may be removed and replaced with a replacement storage chamber (not shown in FIG. 1C) to replenish the debinding fluid in the debinding subsystem 104. In some embodiments, the storage chamber 156 may be removed, refilled with debinding fluid, and reattached to the debinding subsystem 104.

The debinding fluid contained in the storage chamber 156 may be directed to the process chamber 150 containing the inserted printed object 130. In some embodiments, the build material that the printed object 130 is formed of may include a primary binder material and a secondary binder material. In some embodiments, the printed object 130 in the process chamber 150 may be submerged in the debinding fluid for a predetermined period of time. In such embodiments, the primary binder material may dissolve in the debinding fluid while the secondary binder material stays intact.

In some embodiments, the debinding fluid containing the dissolved primary binder material (hereinafter referred to as “used debinding fluid”) may be directed to a distill chamber 152. For example, after the first debinding process, the process chamber 150 may be drained of the used debinding fluid, and the used debinding fluid may be directed to the distill chamber 152. In some embodiments, the distill chamber 152 may be configured to distill the used debinding fluid. In some embodiments, the debinding subsystem 104 may further include a waste chamber 154 fluidly coupled to the distill chamber 152. In such embodiments, the waste chamber may collect waste accumulated in the distill chamber 152 as a result of the distillation. In some embodiments, the waste chamber 154 may be removably attached to the debinding subsystem 104 such that the waste chamber 154 may be removed and replaced after a number of distillation cycles. In some embodiments, the debinding subsystem 104 may include a condenser 158 configured to condense vaporized used debinding fluid from the distill chamber 152 and return the debinding fluid back to the storage chamber 156.

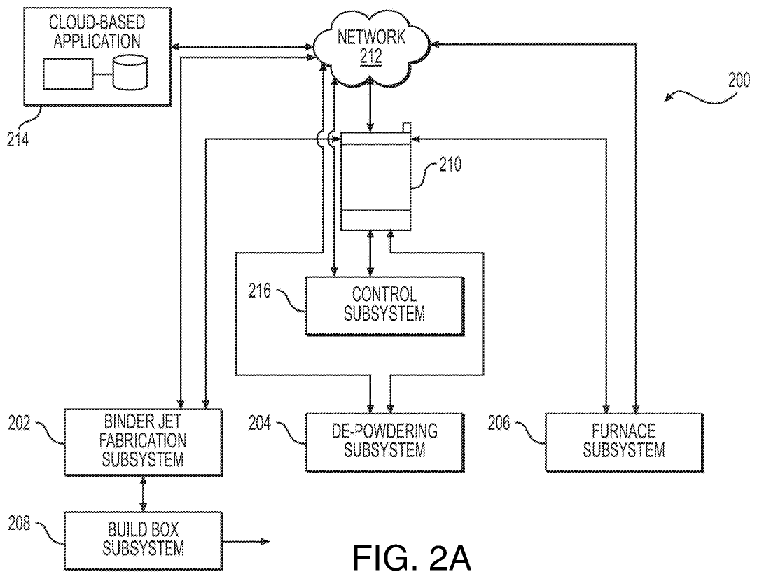

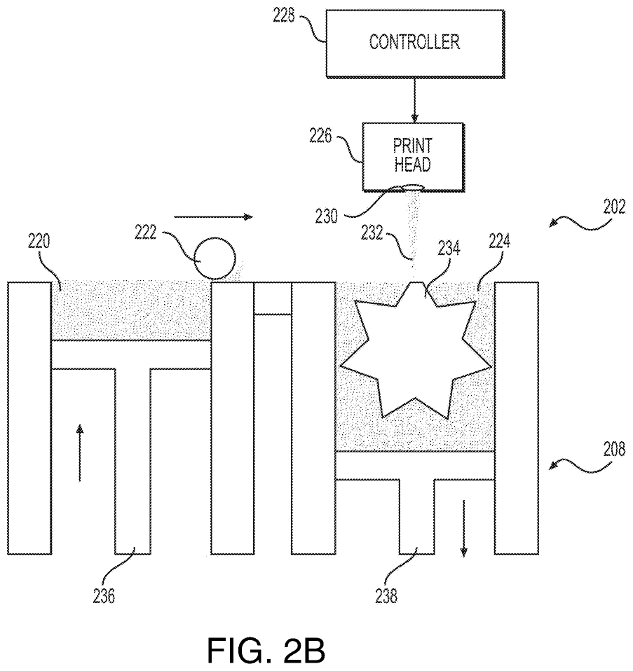

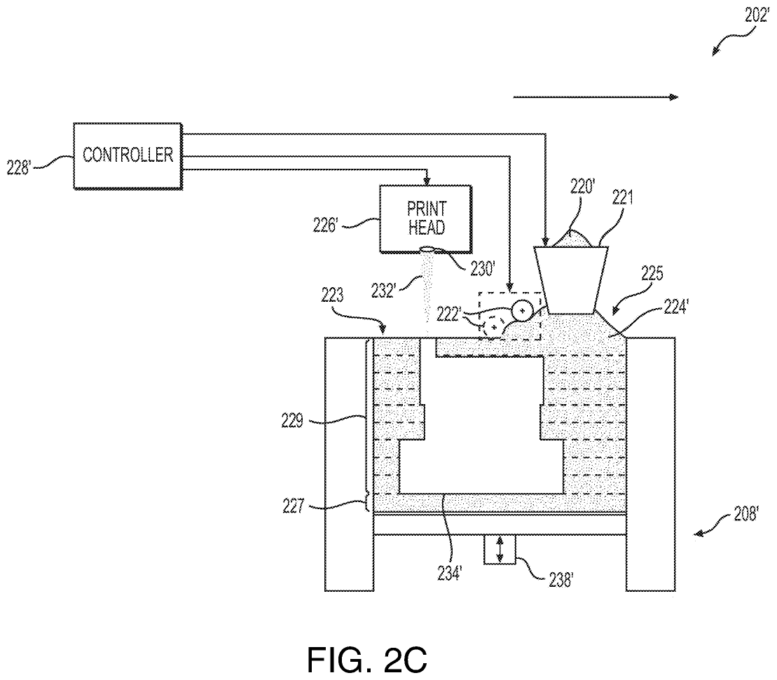

FIG. 2A illustrates another exemplary system 200 for forming a printed object, according to an embodiment of the present disclosure. System 200 may include a printer, for example, a binder jet fabrication subsystem 202, and a treatment site(s), for example, a de-powdering subsystem 204 and the furnace subsystem 106 as described with reference to FIG. 1A. Binder jet fabrication subsystem 202 may be used to form an object from a build material, for example, by delivering successive layers of build material and binder material to a build plate. As shown in FIG. 2A, a build box subsystem 208 may be movable and may be selectively positioned in one or more of binder jet fabrication subsystem 202, de-powdering subsystem 204, and furnace subsystem 106. For example, build box subsystem 208 may be coupled or couplable to a movable assembly. Alternatively, a conveyor (not shown) may help transport the object between portions of system 200.

The build material may be a bulk metallic powder delivered and spread in successive layers. The binder material may be, for example, a polymeric liquid that may be deposited onto and may be absorbed into layers of the build material. One or more of binder jet fabrication subsystem 202, de-powdering subsystem 204, and furnace subsystem 106 may include a shaping station to shape the printed object and a debinding station to treat the printed object to remove a binder material from the build material. Furnace subsystem 106 may heat and/or sinter the build material of the printed object. System 200 may also include a user interface 210, which may be operatively coupled to one or more components, for example, to binder jet fabrication subsystem 202, de-powdering subsystem 204, and furnace subsystem 106, etc. In some embodiments, user interface 210 may be a remote device (e.g., a computer, a tablet, a smartphone, a laptop, etc.). User interface 210 may be wired or wirelessly connected to one or more of binder jet fabrication subsystem 202, de-powdering subsystem 204, and furnace subsystem 106. System 200 may also include a control subsystem 216, which may be included in user interface 210, or may be a separate element.

Binder jet fabrication subsystem 202, de-powdering subsystem 204, furnace subsystem 106, user interface 210, and/or control subsystem 216 may each be connected to the other components of system 200 directly or via a network 212. Network 212 may include the Internet and may provide communication through one or more computers, servers, and/or handheld mobile devices, including the various components of system 200. For example, network 212 may provide a data transfer connection between the various components, permitting transfer of data including, e.g., geometries, the printing material, one or more support and/or support interface details, binder materials, heating and/or sintering times and temperatures, etc., for one or more parts or one or more parts to be printed.

Moreover, network 212 may be connected to a cloud-based application 214, which may also provide a data transfer connection between the various components and cloud-based application 214 in order to provide a data transfer connection, as discussed above. Cloud-based application 214 may be accessed by a user in a web browser, and may include various instructions, applications, algorithms, methods of operation, preferences, historical data, etc., for forming the part or object to be printed based on the various user-input details. Alternatively or additionally, the various instructions, applications, algorithms, methods of operation, preferences, historical data, etc., may be stored locally on a local server (not shown) or in a storage and/or processing device within or operably coupled to one or more of binder jet fabrication subsystem 202, de-powdering subsystem 204, furnace subsystem 106, user interface 210, and/or control subsystem 216. In this aspect, binder jet fabrication subsystem 202, de-powdering subsystem 204, furnace subsystem 106, user interface 210, and/or control subsystem 216 may be disconnected from the Internet and/or other networks, which may increase security protections for the components of system 200. In either aspect, an additional controller (not shown) may be associated with one or more of binder jet fabrication subsystem 202, de-powdering subsystem 204, and furnace subsystem 206, etc., and may be configured to receive instructions to form the printed object and to instruct one or more components of system 200 to form the printed object.

FIG. 2B illustrates an exemplary binder jet fabrication subsystem 202 operating in conjunction with build box subsystem 208. Binder jet fabrication subsystem 202 may include a powder supply 220, a spreader 222 (e.g., a roller) configured to be movable across powder bed 224 of build box subsystem 208, a print head 226 movable across powder bed 224, and a controller 228 in electrical communication (e.g., wireless, wired, Bluetooth, etc.) with print head 226. Powder bed 224 may comprise powder particles, for example, micro-particles of a metal, micro-particles of two or more metals, or a composite of one or more metals and other materials.

Spreader 222 may be movable across powder bed 224 to spread a layer of powder, from powder supply 220, across powder bed 224. Print head 226 may comprise a discharge orifice 230 and, in certain implementations, may be actuated to dispense a binder material 232 (e.g., through delivery of an electric current to a piezoelectric element in mechanical communication with binder material 232) through discharge orifice 230 to the layer of powder spread across powder bed 224. In some embodiments, the binder material 232 may be one or more fluids configured to bind together powder particles.

In operation, controller 228 may actuate print head 226 to deliver binder material 232 from print head 226 to each layer of the powder in a pre-determined two-dimensional pattern, as print head 226 moves across powder bed 224. In embodiments, the movement of print head 226, and the actuation of print head 226 to deliver binder material 232, may be coordinated with movement of spreader 222 across powder bed 224. For example, spreader 222 may spread a layer of the powder across powder bed 224, and print head 226 may deliver the binder in a pre-determined, two-dimensional pattern, to the layer of the powder spread across powder bed 224, to form a layer of one or more three-dimensional objects 234. These steps may be repeated (e.g., with the pre-determined two-dimensional pattern for each respective layer) in sequence to form subsequent layers until, ultimately, the one or more three-dimensional objects 234 are formed in powder bed 224.

Although the example embodiment depicted in FIG. 2B depicts a single object 234 being printed, it should be understood that the powder bed 224 may include more than one object 234 in embodiments in which more than one object 234 is printed at once. Further, the powder bed 224 may be delineated into two or more layers, stacked vertically, with one or more objects disposed within each layer.

An example binder jet fabrication subsystem 202 may comprise a powder supply actuator mechanism 236 that elevates powder supply 220 as spreader 222 layers the powder across powder bed 224. Similarly, build box subsystem 208 may comprise a build box actuator mechanism 238 that lowers powder bed 224 incrementally as each layer of powder is distributed across powder bed 224.

In another example embodiment, layers of powder may be applied to powder bed 224 by a hopper followed by a compaction roller. The hopper may move across powder bed 224, depositing powder along the way. The compaction roller may be configured to follow the hopper, spreading the deposited powder to form a layer of powder.

For example, FIG. 2C illustrates another binder jet fabrication subsystem 202′ operating in conjunction with a build box subsystem 208′. In this aspect, binder jet fabrication subsystem 202′ may include a powder supply 220′ in a metering apparatus, for example, a hopper 221. Binder jet subsystem 202′ may also include one or more spreaders 222′ (e.g., one or more rollers) configured to be movable across powder bed 224′ of build box subsystem 208′, a print head 226′ movable across powder bed 224′, and a controller 228′ in electrical communication (e.g., wireless, wired, Bluetooth, etc.) with one or more of hopper 221, spreaders 222′, and print head 226′. Powder bed 224′ may comprise powder particles, for example, micro-particles of a metal, micro-particles of two or more metals, or a composite of one or more metals and other materials.

Hopper 221 may be any suitable metering apparatus configured to meter and/or deliver powder from powder supply 220′ onto a top surface 223 of powder bed 224′. Hopper 221 may be movable across powder bed 224′ to deliver powder from powder supply 220′ onto top surface 223. The delivered powder may form a pile 225 of powder on top surface 223.

The one or more spreaders 222′ may be movable across powder bed 224′ downstream of hopper 221 to spread powder, e.g., from pile 225, across powder bed 224. The one or more spreaders 222′ may also compact the powder on top surface 223. In either aspect, the one or more spreaders 222′ may form a layer 227 of powder. The aforementioned powder delivery and spreading steps may be successively performed in order to form a plurality of layers 229 of powder. Additionally, although two spreaders 222′ are shown in FIG. 2C, binder jet fabrication subsystem 202′ may include one, three, four, etc. spreaders 222′.

Print head 226′ may comprise one or more discharge orifices 230′ and, in certain implementations, may be actuated to dispense a binder material 232′ (e.g., through delivery of an electric current to a piezoelectric element in mechanical communication with binder material 232′) through discharge orifice 230′ to the layer of powder spread across powder bed 224′. In some embodiments, the binder material 232′ may be one or more fluids configured to bind together powder particles.

In operation, controller 228′ may actuate print head 226′ to deliver binder material 232′ from print head 226′ to each layer 227 of the powder in a pre-determined two-dimensional pattern, as print head 226′ moves across powder bed 224′. As shown in FIG. 2C, controller 228′ may be in communication with hopper 221 and/or the one or more spreaders 222′ as well, for example, to actuate the movement of hopper 221 and the one or more spreaders 222′ across powder bed 224′. Additionally, controller 228′ may control the metering and/or delivery of powder by hopper 221 from powder supply 220 to top surface 223 of powder bed 224′. In embodiments, the movement of print head 226′, and the actuation of print head 226′ to deliver binder material 232′, may be coordinated with movement of hopper 221 and the one or more spreaders 222′ across powder bed 224′. For example, hopper 221 may deliver powder to powder bed 224, and spreader 222′ may spread a layer of the powder across powder bed 224. Then, print head 226 may deliver the binder in a pre-determined, two-dimensional pattern, to the layer of the powder spread across powder bed 224′, to form a layer of one or more three-dimensional objects 234′. These steps may be repeated (e.g., with the pre-determined two-dimensional pattern for each respective layer) in sequence to form subsequent layers until, ultimately, the one or more three-dimensional objects 234′ are formed in powder bed 224′.

Although the example embodiment depicted in FIG. 2C depicts a single object 234′ being printed, it should be understood that the powder bed 224′ may include more than one object 234′ in embodiments in which more than one object 234′ is printed at once. Further, the powder bed 224′ may be delineated into two or more layers 227, stacked vertically, with one or more objects disposed within each layer.

As in FIG. 2B, build box subsystem 208′ may comprise a build box actuator mechanism 238′ that lowers powder bed 224′ incrementally as each layer 227 of powder is distributed across powder bed 224′. Accordingly, hopper 221, the one or more spreaders 222′, and print head 226′ may traverse build box subsystem 208′ at a pre-determined height, and build box actuator mechanism 238′ may lower powder bed 224 to form object 234′.

Although not shown, binder jet fabrication subsystems 202, 202′ may include a coupling interface that may facilitate the coupling and/or uncoupling of the build box subsystems 208, 208′ with the binder jet fabrication subsystems 202, 202′, respectively. The coupling interface may comprise one or more of (i) a mechanical aspect that provides for physical engagement, and/or (ii) an electrical aspect that supports electrical communication between the build box subsystem 208, 208′ to the binder jet fabrication subsystem 202, 202′.

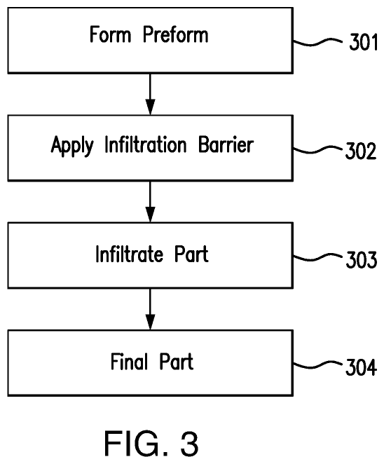

FIG. 3 is a flowchart diagram of an embodiment process. In step 301, the preform is formed. This may optionally be accomplished via an additive manufacturing process such as bound metal deposition or powder bed binder jetting as described above, or may alternatively be via casting, etc. In step 302, the infiltration barrier is selectively applied where desired. In certain embodiments, the infiltration barrier may be co-fabricated with the preform. For example, in a bound metal deposition system, a second nozzle may deposit the material of the infiltration barrier on a layer-by-layer basis along with the material of the preform. In a powder bed binder jetting system, the infiltration barrier may be jetted on a layer-by-layer basis along with or from separate nozzles as the binder. In step 303, the part is infiltrated. Any surfaces that are coated with the interface layer are not wetted, but those left exposed are wetted. In step 304, the final geometry post-infiltration is provided with the high-resolution features (e.g., interior angles) intact.

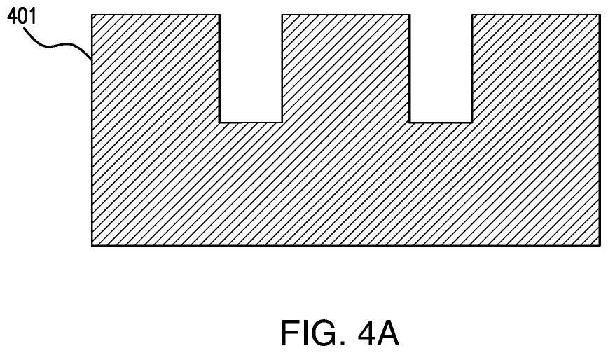

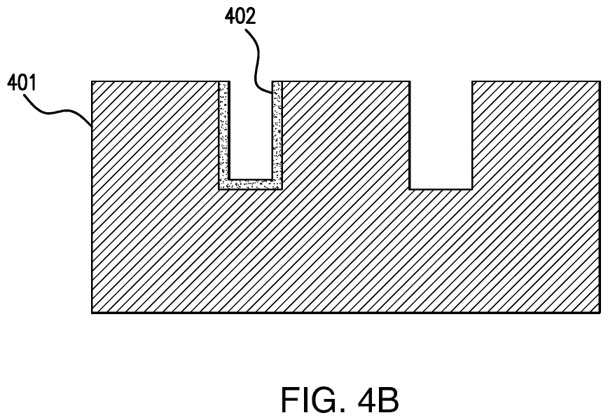

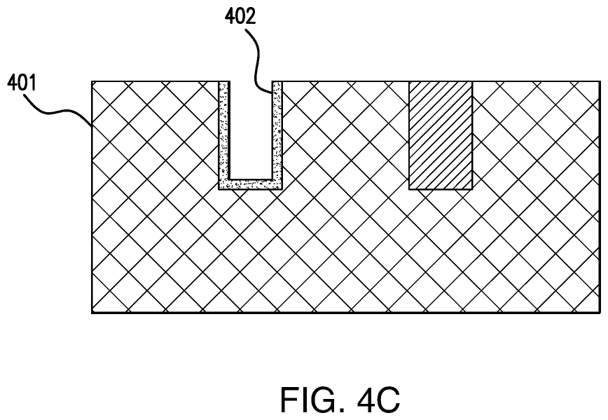

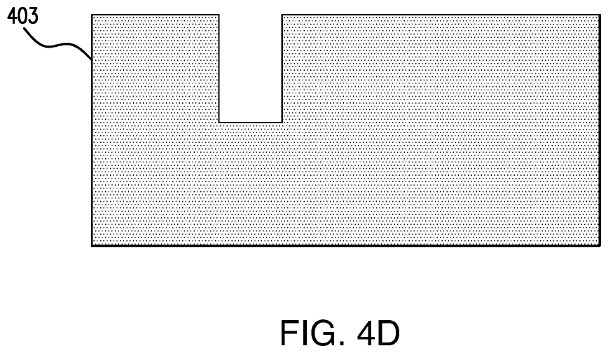

FIG. 4A depicts step 301 of the above described process, showing a cross-section of a preform part 401 having fine geometries. FIG. 4B depicts an infiltration barrier applied to surface 402. FIG. 4C depicts the preform part as it is infiltrated by the infiltrant. FIG. 4D depicts the finished part 403, with the geometry of surface 402 having been maintained.

While FIG. 4 shows an example of a negative feature on a part, it will be appreciated that an infiltration barrier may be used to maintain other features as well. In one embodiment, an infiltration barrier may be used to maintain a sharper radius of curvature than would be allowed by capillary action of the infiltrant alone. Such a situation may occur where one does not desire a corner to become filleted by action of the infiltrant, or to at least reduce this filleting effect. In another embodiment, the bottom portions of a part may be covered in infiltration barrier due to the static head pressure of the height of the infiltrant fluid providing an enhanced driving force for bleeding out of the infiltrant from the bottom of the part as compared to the top of the part. In another embodiment, the infiltration barrier may be used to coat the entirety of the part, often with the exception of spots used at gates wherein the infiltrant may enter the part.

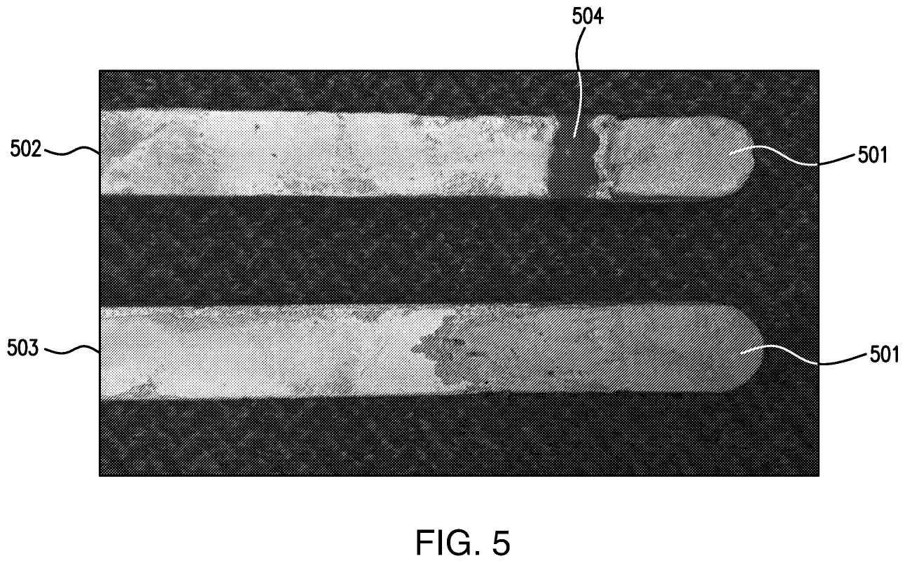

FIG. 5 depicts an embodiment infiltration barrier system as demonstrated on infiltrated bars of steel, particularly A3 tool steel. The starting powder was H12 tool steel. The right ends 501 of the bars 502 and 503 were dipped into the infiltrant melt. As can be seen, the TiO2 infiltration barrier 504 significantly prevented erosion as compared to the case of bar 503 without the barrier.

Application and Removal of Infiltrant Barrier

The infiltration barrier can be applied in numerous ways, including dip coating, painting and spraying of a suspension. This layer may be printed in a similar manner to other support structures and interface layers. For example, during an additive manufacturing process involving forming successive layers of build material to form a preform, the infiltration barrier may be co-fabricated with the preform on a layer-by-layer basis. Depending on part geometries and complexity, spraying the surface of the part or fully immersing the part in a bath containing the interface material may be used to create this protective, non-wetting barrier.

With respect to thickness, as long as the infiltration barrier layer is several particles thick, infiltration should be well-prevented in most cases. However, because local thickness variations may occur in any coating comprising a powder, a healthy margin of safety of several particle diameters is advised for most cases. Specifically, a coating of about 10 particle diameters thick should be sufficient to prevent wetting of the infiltrant into the infiltration barrier, provided the infiltration barrier material has been selected properly. Thinner coatings may also work, but may risk having pinholes depending on the application method and the homogeneity of the coating.

Now discussed is the removal of the infiltration barrier after infiltration, if desired. In some instances, the infiltration barrier may be left after infiltration, if for instance it provided a protective surface or served a purpose in further processing. The infiltration barrier is designed to not be wetted by or react substantially with the infiltrant. Therefore, it is expected that in majority of cases, the infiltration barrier will only be loosely bonded to the infiltrated substrate which is coated onto. The infiltration barrier may be adhered to the body through partial wetting, or through partial sintering, and may be more difficult to remove. If it is desired that the infiltration barrier be removed from the surface of the part, then preferred infiltration barriers will be selected such that they very weakly sinter to itself during infiltration, and such that the infiltration barrier has a very high contact angle with the infiltrant (>90° to assure it does not infiltrate, and preferably >120°). In general, one may alter the sintering temperature of the infiltration barrier by altering the particle size of the infiltrant, with a larger particle size being associated with a higher sintering temperature. In the case of infiltration of aluminum and boron nitride as an infiltration barrier, a particle size of ˜10 microns has been shown to be sufficient. In many cases, as long as the infiltration barrier has a high contact angle and is not strongly sintered to the part, it should be removable with a brush or surface finishing methods. Highly non-adherent infiltration barriers may be removed with a fibrous brush, while more adherent powders may be removed with a steel or brass bristle brush. Still more adherent infiltration barriers may require media blasting (i.e. with sand or grass bead), grinding, tumbling, or another abrasive surface or mechanical removal finishing method. Quenching the part from a high temperature (as during heat treatment) may also thermally shock the infiltration barriers causing them to crack and aid in their removal.

Infiltration Barrier Systems

In general, it is somewhat difficult to get metals to fully wet ionocovalent solids with which they do not substantially react. It will be appreciated by one skilled in the art of metal-ceramic wetting that the details of the wetting process are sensitive to the alloying elements in the infiltrant, the process atmosphere, the temperature, and the morphology of the infiltration barrier. As such, exemplary systems are given below, but should be understood to be capable of manipulation by one skilled in the art.

The general material characteristics of the infiltrant, infiltration barrier, and preform are briefly outlined here to assist one skilled in the art in selecting an appropriate infiltration barrier. Imbibition of an infiltrant into a powder is spontaneous when the contact angle is less than 90°. Thus, it is desired that an infiltration barrier exhibit a contact angle with the infiltrant of greater than 90° at the processing temperature. Higher contact angles are generally better, as less adhesion of the infiltration barrier to the infiltrant will occur. The infiltration barrier is also preferably substantially chemically and physically stable while in the proximity of the infiltrant, preform material, and processing atmosphere over the timescales of the infiltration process. It will be appreciated by one skilled in the art that interfacial reactions of powders with infiltrants are common in the infiltration art (as in the SiC—Al system), and that at specific time and temperature regimes some systems may remain chemically stable enough to serve as an infiltration barrier despite these superficial reactions (again as in the case of the SiC—Al system at temperatures <800° C. and timescales less than approximately one hour at temperature). To facilitate ease of removal, the infiltration barrier is desired to not sinter substantially to itself or two the preform material. As a rule of thumb, for a given infiltration barrier material, one may determine the temperatures at which the material is typically sintered to >80% density, and target temperatures around 200° C. less than these temperatures to assure undesirable sintering does not occur. The particle size of the infiltration barrier material may be increased to yield increases resistance to sintering. The selection of the infiltration barrier particle size depends upon the specific materials systems and applications. However, some general guidance may still be useful. In many application methods using fluids containing ceramic particles (e.g. slurries and suspensions), the particle size should be preferably kept below 50 microns, and often below 10 microns in order to enhance suspension stability and uniformity.

These smaller particle sizes (˜1-10 microns) are also desirable in that they should allow the infiltration barrier to coat the targeted areas of the part with high fidelity—the resolution in the coated region is proportional to the particle size, with finer particles sizes yielding finer resolutions. The above considerations regarding resolution and stability of suspensions are countered by considerations around removal of the infiltration barrier and reactions of the infiltration barrier material with itself and the part. The finer the particle sizes, the greater the chance of such reactions, and generally the higher the cost of the infiltration barrier materials. From the above considerations, the particle sizes of ˜1-10 microns are often a good guiding rule of thumb for most infiltration barrier applications.

Although what is described above assumes that the infiltration barrier maintains its chemistry throughout the processing, it is also possible to form the infiltration barrier by reactions between a material deposited as a precursor to an infiltration barrier and the preform material or the processing atmosphere. For example, a part which is desired to be infiltrated with aluminum may be coated in a boron-containing powder, and heated in a nitrogen-containing atmosphere. The boron would then react with the nitrogen to form a boron nitride compound. In another example, an iron-based preform material may be coated with a powder containing titanium as a precursor to an infiltration barrier, and the titanium may be permitted to oxidize through interactions with the processing atmosphere or via reduction of the surface oxides of the neighboring iron-based preform material.

The composition of the infiltration barrier will generally be a function of the infiltrant and preform system chosen to be infiltrated. In one aspect, the interface layer may usefully contain a component (or be formed of a material) which is substantially non-wetting with respect to the infiltrant at the infiltration temperature. The component may be delivered as a powder in a three-dimensional printing fluid, or coated as a suspension, or otherwise applied in any suitable manner to mask features of interest.

Preferred interface layer materials will also be substantially non-reactive with the preform during processing. For example, in aluminum-aluminum infiltration, boron nitride may be used as such an interface layer preferably below 1000° C. In infiltration with copper-based alloys, graphite may be used, depending on the wetting characteristics of the melt. For copper infiltrant systems, silicon carbide may also be employed. Infiltration of silicon carbide with aluminum can also use boron nitride.

For homogeneous steel infiltration, appropriate infiltration barriers include: aluminum oxide, titanium oxide, magnesium oxide, zirconium oxide, yttrium oxide, hafnium oxide and silicon oxide. For an aluminum infiltrant, alumina may be used below 800° C. Titanium oxide has been used in practice with good results. Monoclinic zirconium oxide may also be employed. Zirconia undergoes a phase transformation from monoclinic to tetragonal at about 1170C with about a 5% volume expansion upon heating. During heating to the infiltration temperature (for steels, generally above 1250° C.), the zirconia is a powder loosely bound to the part, and the volume change is not consequential. Above the transformation temperature, the zirconia will begin to lightly sinter to itself. During cooling, the zirconia powder will be lightly sintered to itself (and possibly the steel surface). The volume change (contraction) upon the reverse reaction during cooling will break up the zirconia layer. In order for the zirconia to be monoclinic at room temperature, it should have no or only low amounts of the oxides that are typically used to stabilize the tetragonal form of zirconia (magnesium oxide, yttrium oxide, calcium oxide and cerium oxide). The upper limits on the amount of zirconia are about 0.5 mol % MgO, 1 mol % Y₂O₃, 1 mol % CaO and 0.5 mol % CeO₂. Adding these other oxides does have an affect on the transformation temperature (lowering it).

Mixed oxides typically used as sand in the foundry industry such as zircon sand (ZrSiO₄), olivine sand (MgFe)2SiO4, chromite sand (FeCr₂O₄) may also be used as infiltration barriers. Other minerals may also be used as infiltration barriers, such as mullite (Al₆Si₂O₁₃), and magnesium-aluminum spinel (MgAl₂O₄).

Although the disclosed subject matter has been described and illustrated with respect to embodiments thereof, it should be understood by those skilled in the art that features of the disclosed embodiments can be combined, rearranged, etc., to produce additional embodiments within the scope of the invention, and that various other changes, omissions, and additions may be made therein and thereto, without parting from the spirit and scope of the present invention.

What is claimed:

1. A method of maintaining part geometry fidelity during infiltration of a three-dimensional object, comprising the steps of:
additively manufacturing a preform of a desired shape;
forming an infiltration barrier on at least a portion of a surface of the preform;
infiltrating the preform with an infiltrant to densify the preform into an infiltrated three-dimensional object;
wherein the infiltration barrier maintains the geometry of the portion of the surface of the preform.

2. The method of claim 1 wherein the infiltration barrier is non-wetting with respect to the infiltrant.

3. The method of claim 1, wherein the step of additively manufacturing the preform includes powder bed binder jetting additive manufacturing.

4. The method of claim 1, wherein the step of additively manufacturing the preform includes bound metal deposition additive manufacturing.

5. The method of claim 1, wherein the step of additively manufacturing the preform includes stereolithographic manufacturing.

6. The method of claim 1 wherein the preform includes aluminum nitride, the infiltrant includes aluminum and the infiltration barrier includes boron nitride.

7. The method of claim 1 wherein the preform includes stainless steel, the infiltrant includes copper and the infiltration barrier includes graphite.

8. The method of claim 1 wherein the infiltration barrier is co-fabricated with the preform.

9. The method of claim 1 wherein the infiltration barrier is formed by spraying.

10. The method of claim 1 wherein the infiltration barrier is formed by at least partially submerging the preform into a container of the infiltration barrier.

11. A method of maintaining part geometry fidelity during infiltration of a metallic three-dimensional object, comprising the steps of:
additively co-fabricating a metallic preform of a desired shape and an infiltration barrier on a geometric feature of the metallic preform;
infiltrating the metallic preform with an infiltrant to densify the metallic preform into an infiltrated three-dimensional object; and
wherein the infiltration barrier maintains the geometric feature during infiltration.

12. The method of claim 11 wherein the infiltration barrier is non-wetting with respect to the infiltrant.

13. The method of claim 11 wherein the infiltration barrier includes boron nitride.

14. The method of claim 11 wherein the infiltration barrier includes graphite.

15. A method of manufacturing a three-dimensional object of a desired shape, comprising the steps of:
additively manufacturing a metallic preform of a desired shape from a build material including a metal powder and a binder system;
debinding at least a portion of the binder system;
applying an infiltration barrier to a geometric feature of the metallic preform, the infiltration barrier being non-wetting with respect to an infiltrant; and
infiltrating the metallic preform with an infiltrant to densify the metallic preform into an infiltrated three-dimensional object; and
wherein the infiltration barrier maintains the geometric feature during infiltration.

16. The method of claim 15, wherein the step of additively manufacturing the metallic preform includes powder bed binder jetting.

17. The method of claim 15, wherein the step of additively manufacturing the metallic preform includes bound metal deposition.

18. The method of claim 15 wherein the metallic preform includes aluminum nitride, the infiltrant includes aluminum and the infiltration barrier includes boron nitride.

19. The method of claim 15 wherein the metallic preform includes stainless steel, the infiltrant includes copper and the infiltration barrier includes graphite.

20. The method of claim 15 wherein the infiltration barrier is formed by one of spraying and at least partially submerging the metallic preform into a container of the infiltration barrier.
